(19) United States
(12) Patent Application Publication
(10) Pub. No.: US 2019/0282422 A1
(43) Pub. Date: Sep. 19, 2019

(54) Arm Support Device and Method

(71) Applicant: Hope Rope LLC, Brownsville, TX (US)

(72) Inventor: Lawrence R. Johnson, Brownsville, TX (US)

(73) Assignee: Hope Rope LLC, Brownsville, TX (US)

(21) Appl. No.: 15/921,358

(22) Filed: Mar. 14, 2018

(51) Int. Cl. A61G 13/12; A61G 15/12

(52) U.S. Cl. CPC A61G 13/124; A61G 2210/00; A61G 13/1235; A61G 15/12

(57) ABSTRACT

Systems and methods of the disclosed embodiments may include an arm support device for the arms of a person. The device may include a first loop sized to receive a first arm when the first arm is positioned at a release position relative to the first loop, and to hold the first arm secure when the first arm is positioned at a securing position relative to the first loop, and a second loop sized to receive a second arm when the second arm is positioned at a release position relative to the second loop, and to hold the second arm secure when the second arm is positioned at a securing position relative to the second loop. The first loop may be connected with the second loop so as to support the person's arms when in a relaxed state.

### BACKGROUND

This section is intended to provide relevant background information to facilitate a better understanding of the various aspects of the described embodiments. Accordingly, it should be understood that these statements are to be read in this light and not as admissions of prior art.

Medical patients can often have difficulty feeling comfortable during their time undergoing medical treatment or procedures. From the time the person gets to the treatment center, whether at the dentist, doctor's office, hospital, or other location, they can face stressful situations. For example, waiting in the waiting room, getting the right information to the front desk, getting dressed for the examination or medical treatment, and waiting in the treatment room can all cause stress and make the patient nervous or agitated. The procedures can require the person to remain still while the procedure is conducted, exacerbating nervousness and agitation. To add to this difficulty, many examination tables in treatment rooms do not have support structures to keep patients' arms supported while they sit. Many patients end up folding their arms, letting them dangle to their sides, or holding their hands in their lap. These options can often cause fatigue in arm or hand muscles, which increases discomfort. The stress and fatigue can be directly related to the person's frame and body weight. Extra bodily mass and volume requires the person to use extra effort to keep their arms in their lap, folded, or otherwise in front of their body.

Lying down on the examination table during a procedure or scan can also cause distress in a similar manner. That is, examination tables often do not have arm rests, and can be narrow enough that a patient's body and arms do not both fit on the width of the exam table. Since there is not enough room to lay their arms on the table, the patient must fold them over their body, or let them dangle loose down the sides of the examination table toward the ground. Dangling arms can cause stress on muscles and joints, and folding arms can also cause fatigue, especially if the patient has a large frame to fold their arms across.

Even people who are not patients may feel more comfortable with their arms supported in a relaxed state, allowing the person to feel overall more relaxed. For example, people with soreness or injury may feel more comfortable with their arms supported while in a seated or lying position. People who may experience deficit disorder symptoms or possibly in a nervous, agitated, or overly energized state may also feel more comfortable and calm with their arms supported while in a relaxed state.

### BRIEF DESCRIPTION OF THE DRAWINGS

Embodiments of the arm support device and method are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a schematic diagram of a person wearing an arm support device, according to one or more embodiments;

FIG. 2 is a perspective view of the arm support device of FIG. 1, according to one or more embodiments;

FIG. 3 is a perspective view of the arm support device of FIG. 1 supported the first hand and the second hand of a patient, according to one or more embodiments;

FIG. 4 is a perspective view of a person using the arm support device of FIG. 1 while lying on an examination table;

FIG. 5 is a perspective view of a person using the arm support device of FIG. 1 while lying on an examination table;

FIG. 6 is a perspective view of a person using the arm support device of FIG. 1 while lying on an examination table;

FIG. 7 is a perspective view of a person using the arm support device of FIG. 1 while lying on an examination table;

FIG. 8 is a perspective view of a person using the arm support device of FIG. 1 while sitting in an examination chair; and

FIG. 9 is a perspective view of a person using the arm support device of FIG. 1 while sitting in an examination chair.

### DETAILED DESCRIPTION

The present disclosure provides an apparatus and method to support a person's arms while they are sitting or lying down, such as for example, on an examination table. The device is self-supporting, requiring no assistance to implement. Specifically, the person using the device may be received into the device, and be released from the device without another person present. The person assumes a securing position with their hands and/or arms, and then relaxes while a procedure is performed (e.g., medical procedure or scan). Furthermore, the apparatus and method can provide psychological relief or comfort from stress felt during an agitated situation, even with people who are not patients.

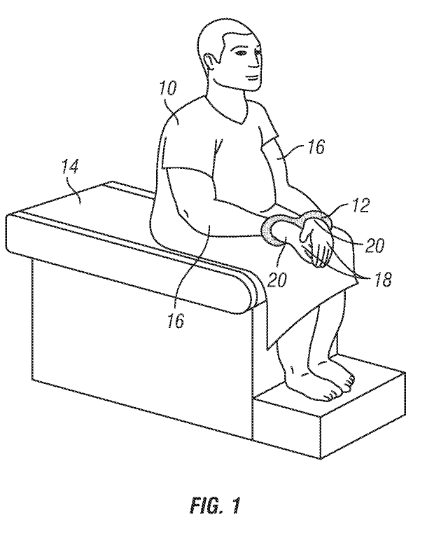

FIG. 1 is a schematic diagram of a person 10 wearing an arm support device 12, according to one or more embodiments. The person 10 may employ the arm support device 12 while sitting on an examination table 14 while a doctor proceeds with a medical evaluation or procedure. For example, the person 10 may be in a physician's office or at a hospital. The typical examination table 14, as illustrated, has no arm rests or support structures at the edges of the table 14. If the person 10 were to relax their arms 16 and hands 18 without the arm support device 12, the arms 16 and hands 18 would drop to the side of the table 14. With the arm support device 12, however, the arms 16 are self supported, allowing the person to relax. That is, since the arm support device 12 is secured around each wrist 20 of the person 10, the arms 16 are held in place and supported. As illustrated below, the person 10 may comfortably use other configurations, depending on preference, to release and secure the arms 16 and hands 18.

In addition to supporting the arms 16 of the person 10, the arm support device 12 may also calm a person that has a tendency to fidget. If a doctor is trying to examine the person 10, it can be helpful if the person does not move. Some people 10, however, especially young individuals, have an inclination to wiggle or poke at items around the examination table 14, or at their own clothes. For example, a person 10 may have attention-deficit disorder, attention-deficit hyperactivity disorder, or other similar disorder that causes an inability to keep oneself still. Rather than restraining the person 10 to keep them from moving, the disclosed embodiments instead rely on merely having a physical reminder. It has been found that the calming effect of slight support, without restraint, can calm individuals in situations where they would otherwise experience feelings of agitation.

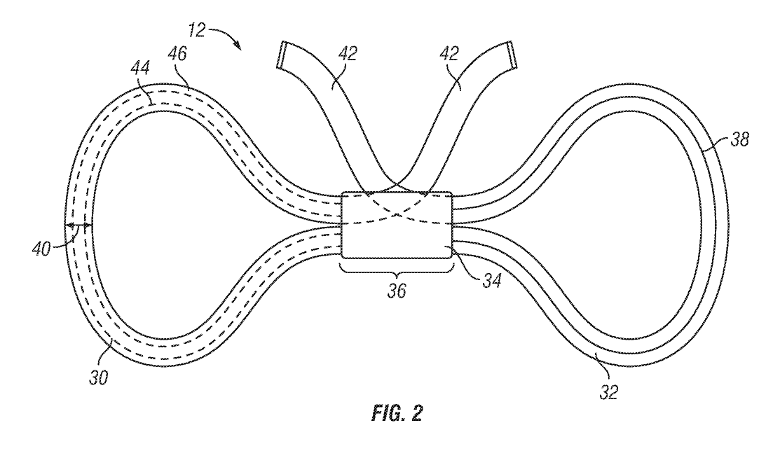

FIG. 2 is a perspective view of the arm support device 12 of FIG. 1, according to one or more embodiments. The arm support device 12 has a first loop 30 and a second loop 32. A connector 34 holds the first loop 30 and the second loop 32 together. The connector 34 may have a length 36 that separates the first loop 30 from the second loop 32. The length 36 may be selected based on a preference of the person 10. The length 36 may be greater if the person 10 prefers to have more space between their arms 16, and conversely the length 36 may be smaller if the person 10 prefers to have less space between their arms 16.

The first loop 30 and the second loop 32 may also have sizes that are based on the person's 10 preferences. For example, the loops 30, 32 may have a length 38 that is sized to fit around and receive a hand 18 from the person 10. The length 38, in certain embodiments, is sized so that the loop 30, 32 fits around the hand 18 when the hand 18 is positioned at a release position, and holds the hand 18 when the hand 18 is positioned at a securing position. For example, the release position may be when the hand 18 is held straight in-line with the arm 16, and held perpendicular to the loop 30, 32. The securing position may thus be when the hand 18 is not in a straight line with the arm 16, or when the hand 18 is at a non-perpendicular angle with respect to the loop 30, 32. The length 38 of the loop 30, 32 may adjust the range of the release position, making it easier or more difficult to slip the hand 18 out of the loop 30, 32.

The first loop 30 and the second loop 32 may also have a width 40 that is selected by the person 10 for comfort. In certain embodiments, the width 40 is selected based on a desire for the loop 30, 32 to not dig too much into the person's arm 16. A loop 30, 32 having a greater width 40 is able to spread out the force of holding the arms 16 together over a greater area, and thus reduces the pressure on any particular point of the person's arm 16. Certain embodiments of the arm support device 12 include a width 40 that is greater than half of a diameter of at least one of the wrists 20, to make sure that the person does not have the loop 30, 32 indent into the wrist 20.

In certain embodiments, each of the adjustable sizes (i.e., connector width 36, loop length 38 and loop width 40) of the arm support device 12 may be individually adjusted. For example, one embodiment may be able to adjust the loop length 38, while another embodiment may be able to adjust the connector width 36. Still further embodiments may be able to adjust all the adjustable sizes. The connector width 36 may be adjustable, for example, by adding or subtracting material to the connector 34. The loop length 38 may be adjustable by changing the amount of the loop 30, 32 that is held by the connector 34. The connector 34, in certain embodiments, may be able to loosen a grip around the first loop 30 or the second loop 32 to enable extra loop material 42 to slide into or out of the connector 34 to create a larger or smaller loop 30, 32. The connector 34 may then tighten the grip again to make sure that the loops 30, 32 do not adjust while the person 10 is relaxed. Other embodiments may include other ways to adjust the length 38 of the loops 30, 32. Certain embodiments may also have a length 38 that is not adjustable. The loop width 40 may be adjusted, for example, by changing a weave pattern of the loop 30, 32.

The loops 30, 32 may be made from a material that is soft and pliable so as to be comfortable for the person 10 even after long periods of waiting for the medical evaluation or procedure. For example, the loops 30, 32 may include rope, webbing, plastic, rubber, ribbon, fabric, or combinations thereof. Certain embodiments may include a ribbing 44 that keeps the loop 30, 32 in a general shape, while also allowing an external sheath 46 to conform somewhat to the arms 16 of the person 10. The connector 34 may also include a variety of materials to maintain structure and strength in holding the loops 30, 32 together, while also being comfortable for the person 10. For example, the connector 34 may include metal, plastic, tape, wood, shrink wrap, or other materials that are covered with fabric or other soft material for comfort.

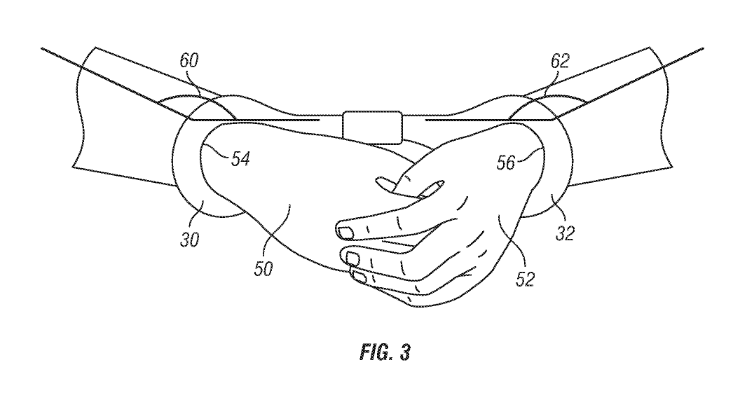

FIG. 3 is a close-up perspective view of the arm support device 12 of FIG. 1 or 2 supporting a first hand 50 and a second hand 52 of the person 10 in a securing position, according to one or more embodiments. This securing position has the first hand 50 and the second hand 52 folded into each other. The first loop 30 fits around the first arm 16 and sits securely on a first wrist 54. The second loop 32 fits around the second arm 16 and sits securely on a second wrist 56. Positioning the first arm 16 at a first securing position 60 with respect to the first loop 30 ensures that the first loop 30 stays on the first wrist 54 or some other position on the first arm 16. Positioning the second arm 16 at a second securing position 62 with respect to the second loop 32 ensures that the second loop 32 stays on the second wrist 56 or some other position on the second arm 16. If the person 10 desires either arm 16 to release from either loop 30, 32, the person 10 changes the position 60, 62 to the release position and slips the hands 50, 52 out of the loops 30, 32. In certain embodiments, the release position is at an angle of about 90 degrees, and the securing position 60, 62 is any position that is not the release position.

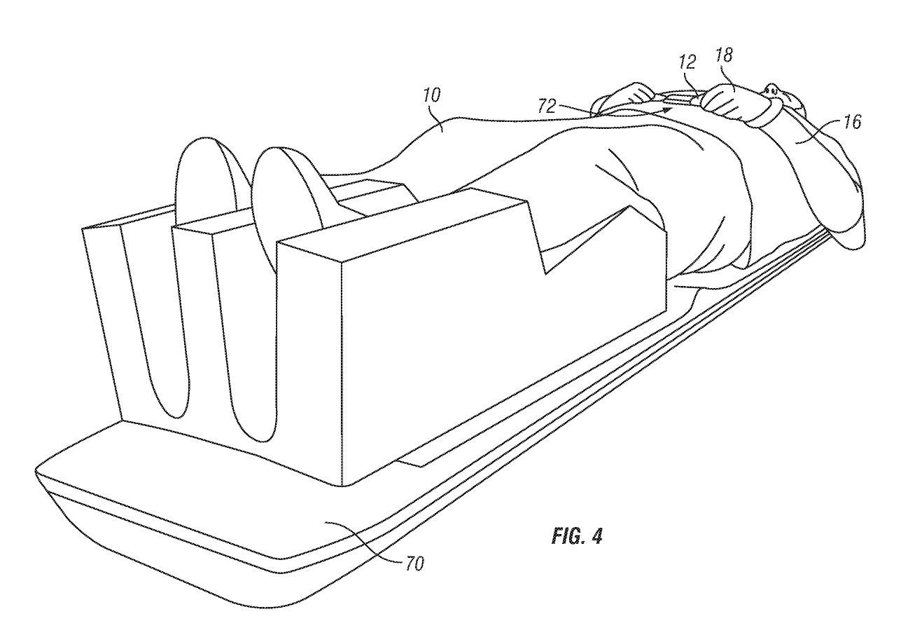

FIG. 4 is a perspective view of the person 10 resting the arm support device of FIG. 1 on their body 68 while lying on a procedure table 70. The arm support device 12 is self- supporting, and may provide a similar solution when the person is lying down on the examination table 14 of FIG. 1. Indeed, the problem of arms 16 dropping to the side of the procedure table 70 can be more critical because certain agitating procedures are conducted while the person 10 is lying down. For example, the person 10 may be encompassed by a magnetic resonance imaging (MRI) machine while lying down to receive an MRI scan. Agitation can be compounded when the person 10 feels like their hands 18 may touch the MRI machine when they are not supposed to. The person 10 may feel comforted when they know that they can relax their arms 16, and their arms 16 will remain in the securing position across their body. The person 10 will likely not feel agitation from the arm support device 12 because the person 10 can easily remove their hands 18 from the arm support device 12 without assistance from another person (e.g., medical technician). The person 10 may just change the position of their hand 18 from the securing position to a release position.

The person 10 in FIG. 4 is using a securing position where the hands 18 are positioned through the loops 30, 32 and then either hands 18 or fingers are wrapped around the arm support device 12 and/or the loops 30, 32. The hands 18 may then be positioned so that the loops 30, 32 are taut around the wrists 20. The securing position with the hands 18 around the loops 30, 32 and the loops 30, 32 taut around the wrists 20 allows the person 10 to relax their arms in a wider position than they would use with the folded hands securing position illustrated in FIG. 3. The securing position of the hands 18 may also include a location of the arm support device 12 relative to the body of the person 10. For example, in FIG. 4, the arm support device 12 is located across a midsection 72 of the person 10. The location for the arm support device 12 may be dictated by certain procedures, or may be chosen out of comfort based on preference. The arm support device 12 in the illustrated embodiment may be constructed of material that is transparent to scanning methods used in the medical procedures. The transparency means that the securing position with the hands 18 through the loops 30, 32, and the hands 18 or fingers wrapped around the arm support device 12 enables internal imaging of the entire abdominal and chest cavities without the arms 16 or hands 18 getting in the imaging area.

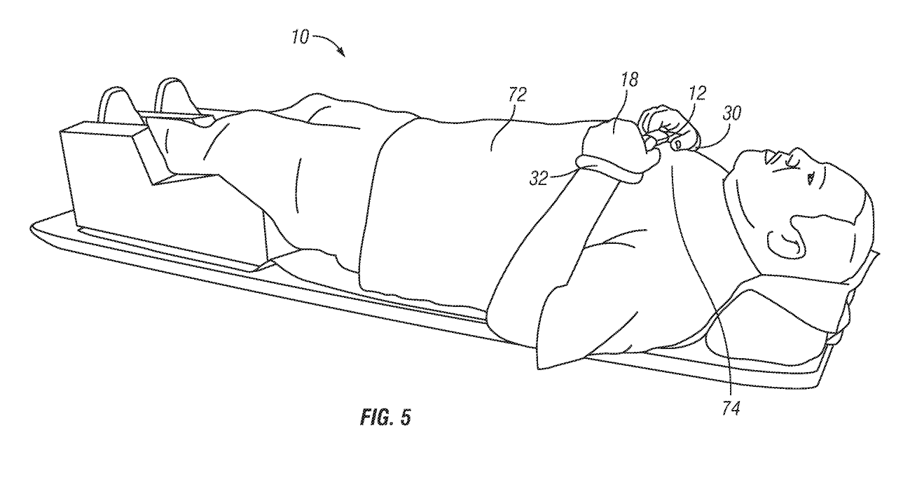

FIG. 5 is a perspective view of the person 10 using the arm support device 12 of FIG. 1 while lying on the procedure table 70 of FIG. 4. The person 10 is positioning the hands 18 through the loops 30, 32 and wrapping the hands 18 or fingers around the arm support device 12, similarly to the securing position illustrated in FIG. 4. Rather than locating the arm support device 12 at the midsection 72, however, the person 10 is employing a securing position with the arm support device 12 across a chest 74. This securing position may be used, for example, when the procedure is a scan of abdominal organs, and the arms 16 and hands 18 must be out of the way. The arm support device 12 may be constructed of material that is transparent to scanning methods used in the medical procedures. The transparency means that the securing position with the hands 18 through the loops 30, 32, and the hands 18 or fingers wrapped around the arm support device 12 enables internal imaging of the entire abdominal and chest cavities without the arms 16 or hands 18 getting in the imaging area.

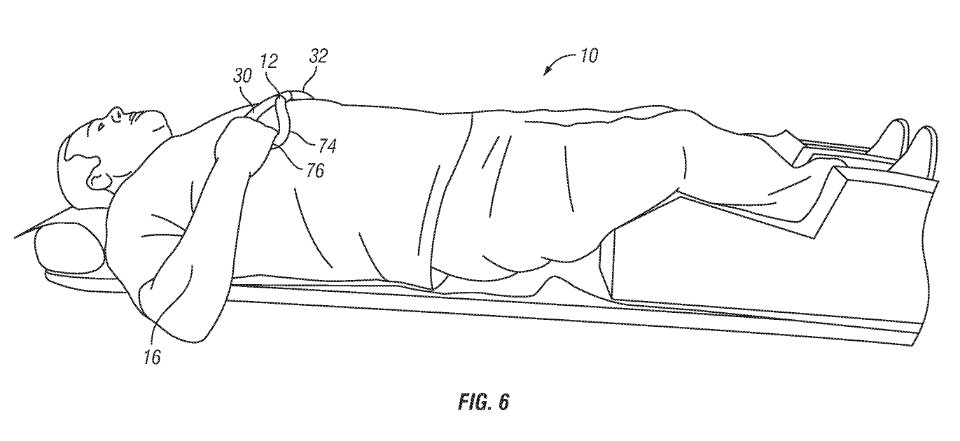

FIG. 6 is a perspective view of a person 10 using the arm support device 12 of FIG. 1 while lying on the procedure table 70 of FIG. 4 or FIG. 5. The person 10 is employing a securing position where the hands 18 are holding an end 76 of the loops 30, 32. This securing position enables the person 10 to have a position for their arms 16 that is even wider than the position illustrated in FIGS. 4 and 5. The arm support device 12 may be constructed of material that is transparent to scanning methods used in the medical procedures. The transparency means that the securing position with the wide holding of the ends 76 enables internal imaging of the entire abdominal and chest cavities without the arms 16 or hands 18 getting in the imaging area.

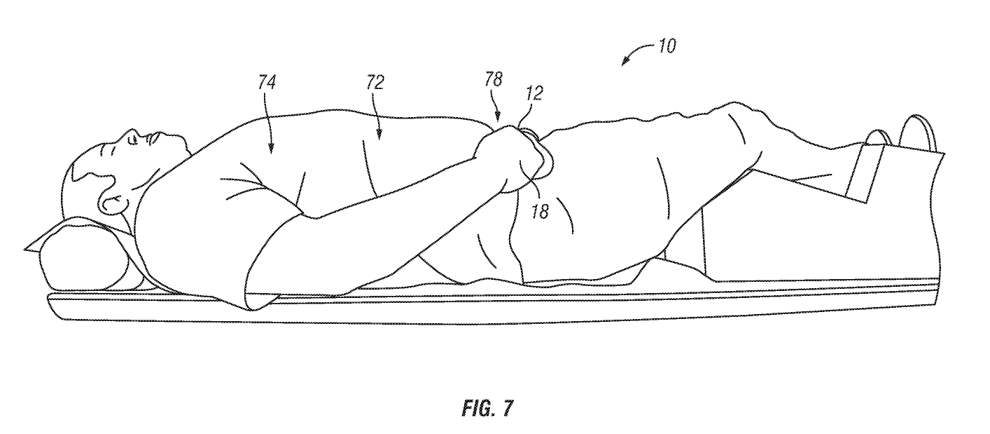

FIG. 7 is a perspective view of a person 10 using the arm support device 12 of FIG. 1 while lying on the procedure table 70. The person 10 is employing the securing position where the hands 18 are holding the ends 76 of the loops 30, 32. This securing position also enables the person 10 to located their arms 16 along their length and locate the arm support device across their pelvis 78. This similarly enables internal imaging of the entire abdominal and chest cavities without the arms 16 or hands 18 getting in the imaging area.

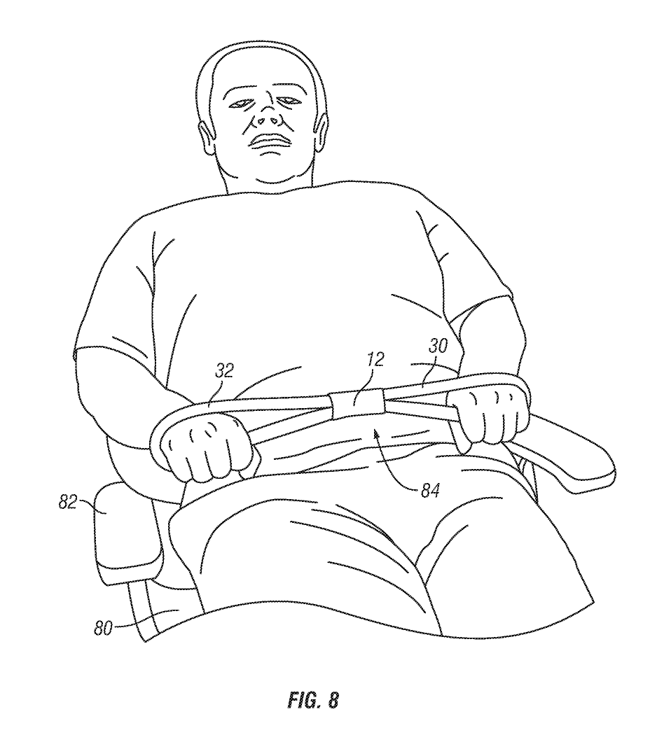

FIG. 8 is a perspective view of a person 10 using the arm support device 12 of FIG. 1 while sitting in an examination chair 80. The examination chair 80 may be used in a dentist's office, for example. The examination chair 80 may have arm rests 82 where the person 10 may rest their arms 16 or hands 18. During the procedure, however, a person 10 holding the arm rests 82 can end up grasping an end 84 of the arm rest 82 with their hands 18, which causes the person 10 to tense up. Using the arm support device 12 enables the person 10 to customize their securing position of choice (e.g., locating the arm support device 12 at a location in the person's 10 lap 84), so that the arms 16 and hands 18 are secured and stationary in a position and location of their preference, rather than only being able to rest their hands 18 on the arm rests 82. The person 10 illustrated in FIG. 8 has their arms 16 and hands 18 positioned at a securing position in which the hands 18 are received into the loops 30, 32 and are wrapped around only one side of the loop 30, 32. The loops 30, 32 may be wrapped taut around the wrists 20, but may also be positioned just around the top of the hands 18.

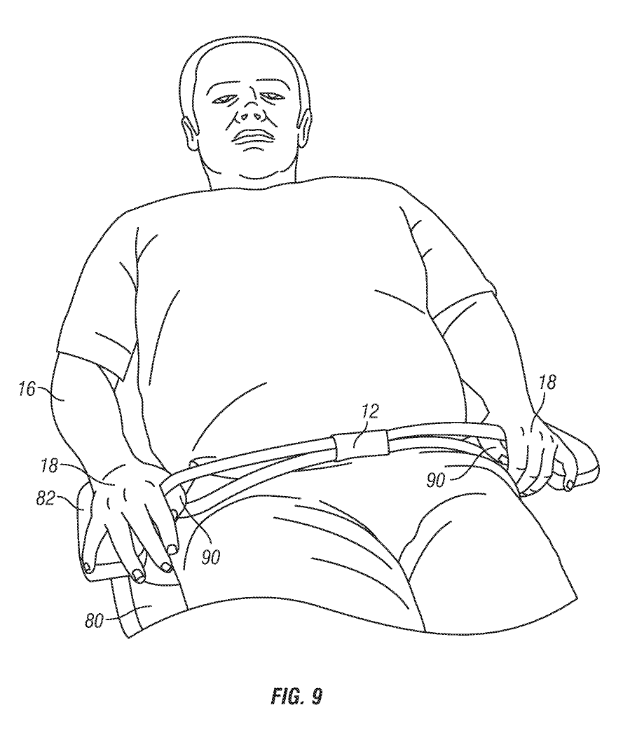

FIG. 9 is a perspective view of a person 10 using the arm support device 12 of FIG. 1 while sitting in the examination chair 80 of FIG. 8. The person 10 illustrated in FIG. 9 has their arms 16 and hands 18 positioned at a securing position in which only the person's thumbs 90 are received into the loops 30, 32. This securing position may be employed, for example, when the arm rests 82 are freely rotatable and/or adjustable to positions that the person 10 finds uncomfortable. In some examination chairs 80, the arm rests 82 rotate to a wider position and must be pulled back in, which does not allow the person 10 to relax. The securing position holding with just thumbs 90 enables the person 10 to use the arm rest 82 while still keeping the arms 16 and hands 18 still and secure.

One or more specific embodiments of the arm support device 12 have been described. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

Certain terms are used throughout the description and claims to refer to particular features or components. As one skilled in the art will appreciate, different persons may refer to the same feature or component by different names. This document does not intend to distinguish between components or features that differ in name but not function.

Reference throughout this specification to “one embodiment,” “an embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. An arm support device for supporting a first arm and a second arm of a person, comprising:
a first loop sized to receive the first arm or a first hand when the first arm or the first hand is positioned at a release position relative to the first loop, and to hold the first arm or the first hand secure when the first arm or the first hand is positioned at a securing position relative to the first loop;
a second loop sized to receive the second arm or a second hand when the second arm or the second hand is positioned at a release position relative to the second loop, and to hold the second arm or the second hand secure when the second arm or second hand is positioned at a securing position relative to the second loop; and
wherein the first loop is connected with the second loop so as to support the person's first arm and second arm when in a relaxed state.

2. The arm support device of claim 1, further comprising a connector positioned and engaged with the first and second loops to connect the first and second loop.

3. The arm support device of claim 2, wherein the connector loosens and tightens a grip around the first loop to adjust a size of the first loop, loosens and tightens a grip around the second loop to adjust a size of the second loop, or combination thereof.

4. The arm support device of claim 2, wherein the connector comprises rope, fabric, woven material, braided material, tape, metal, plastic, or any combination thereof

5. The arm support device of claim 2, wherein the connector comprises a soft covering.

6. The arm support device of claim 1, wherein the first loop comprises a width that is at least half of the diameter of the first arm or the second arm.

7. The arm support device of claim 1, wherein the first loop, second loop, or combination thereof comprises a material that is soft and pliable.

8. The arm support device of claim 1, wherein the first loop, the second loop, or both comprises rope, webbing, plastic, rubber, ribbon, fabric, or any combinations thereof.

9. The arm support device of claim 1, comprising a ribbing configured to keep a shape of the first loop or the second loop.

10. A method of supporting arms of a person, comprising:
receiving at least a portion of a first arm or a first hand into a first loop, wherein the first loop is sized to fit around the first arm or the first hand when the first arm or the first hand is positioned at a release position relative to the first loop, and to hold the first arm secure when the first arm or the first hand is positioned at a securing position relative to the first loop;
receiving at least a portion of a second arm or a second hand into a second loop, wherein the second loop is sized to fit around the second arm or the second hand when the second arm or second hand is positioned at a release angle relative to the second loop, and to hold the second arm secure when the second arm is positioned at a securing angle relative to the second loop; and
supporting the first arm and the second arm using the first and second loops while the person's arms are relaxed.

11. The method of claim 10, further comprising connecting the first and second loops with a connector.

12. The method of claim 10, comprising adjusting a length of the first loop or a length of the second loop.

13. The method of claim 10, comprising connecting the first and second loops with a connector and adjusting the size of the first and second loops with the connector.

14. The method of claim 10, wherein the medical procedure comprises scanning the person with a magnetic resonance imaging machine.

15. The method of claim 10, comprising locating the arm support device at a particular location relative to a body of the person.

16. The method of claim 15, wherein the particular location is a midsection location, a chest location, a pelvis location, or a lap of the person.
